(19) United States
(12) Patent Application Publication
(10) Pub. No.: US 2010/0009621 A1
(43) Pub. Date: Jan. 14, 2010

(54) EXTERNAL ROTOR BRUSHLESS DC MOTOR DRIVEN EXHAUST FAN

(76) Inventor: Te-Hsuan HSIEH, Taichung City (TW)

Correspondence Address: Dr. BANGER SHIA;Int''l Patent Office of Bang Shia, 102 Lindencrest Ct, Sugar Land, TX, 77479-5201, US

(21) Appl. No.: 12/172,207

(22) Filed: Jul. 11, 2008

(51) Int. Cl. F24F 13/078; F21V 21/04

(52) U.S. Cl. 454/293; 454/349; 362/364

(57) ABSTRACT

An external rotor brushless DC motor driven exhaust fan is provided with an external rotor brushless DC motor and a LED illumination device in its inner space. The uses of the external rotor brushless DC motor and the low voltage driven LED illumination device enable the exhaust fan to have the functions of air exhausting and illumination, and to reduce the power consumption and noise. On top of that, the reduction in power consumption of the external rotor brushless DC motor can lower the carbon emission of the exhaust fan, so the exhaust fan is not only environmentally friendly but also energy saving.

### BACKGROUND OF THE INVENTION

1. Field of the Invention

The present invention relates to an exhaust fan, and more particularly to an external rotor brushless DC motor driven exhaust fan with a LED illumination device, which is not only environmentally friendly but also energy saving.

2. Description of the Prior Art

A conventional AC motor driven exhaust fan usually has the disadvantages of noise pollution and high power consumption, which is inconsistent with the concept of saving the Earth by reduction of carbon emission.

On top of that, exhaust fan is usually used in a household or public toilet room. Let s take the household toilet room for example, in addition to an exhaust fan, on the ceiling of the toilet room must also be provided an illumination device for the purpose of illumination and ventilation.

However, arranging an illumination device and an exhaust fan simultaneously on the ceiling is not only time consuming, requires complicated cable arrangement, but also will affect the appearance of the ceiling.

The present invention has arisen to mitigate and/or obviate the afore-described disadvantages.

### SUMMARY OF THE INVENTION

The primary objective of the present invention is to provide an external rotor brushless DC motor driven exhaust fan with a LED illumination device, which is capable of solving the abovementioned problems of the conventional AC motor driven exhaust fan.

An external rotor brushless DC motor driven exhaust fan provided by the present invention comprises: a housing defined with an axial inner space with its open side facing downward and a vent located above the inner space; a cover detachably assembled to the open side of the housing for sealing the open side of the housing, in each side of the rectangular guiding frame being defined an air guiding hole; an external rotor brushless DC motor and a LED illumination device disposed at the vent and provided with a turbo fan.

When the external rotor brushless DC motor is turned on, it will rotate the turbo fan so as to suck air of room via the air guiding hole and then discharge it out of the room, meanwhile, the LED illumination DEVICE is turned on to illuminate the room.

### BRIEF DESCRIPTION OF THE DRAWINGS

FIG. 1 is a perspective view illustrating the exploded components of an external rotor brushless DC motor driven exhaust fan in accordance with a preferred embodiment of the present invention;

FIG. 2 is a perspective view illustrating the assembly of the external rotor brushless DC motor driven exhaust fan in accordance with the preferred embodiment of the present invention; and

FIG. 3 is a cross sectional view illustrating the assembly of the external rotor brushless DC motor driven exhaust fan in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

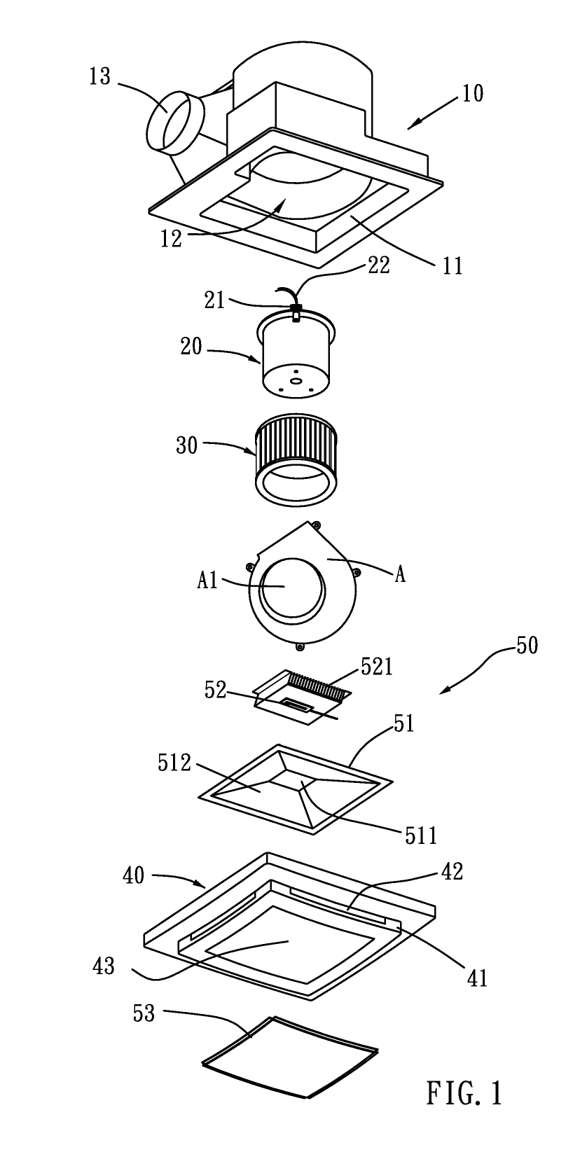

Referring to FIG. 1, an external rotor brushless DC motor driven exhaust fan in accordance with a preferred embodiment of the present invention comprises: a housing 10, an external rotor brushless DC motor 20, a turbo fan 30, a cover 40, and a LED illumination device 50.

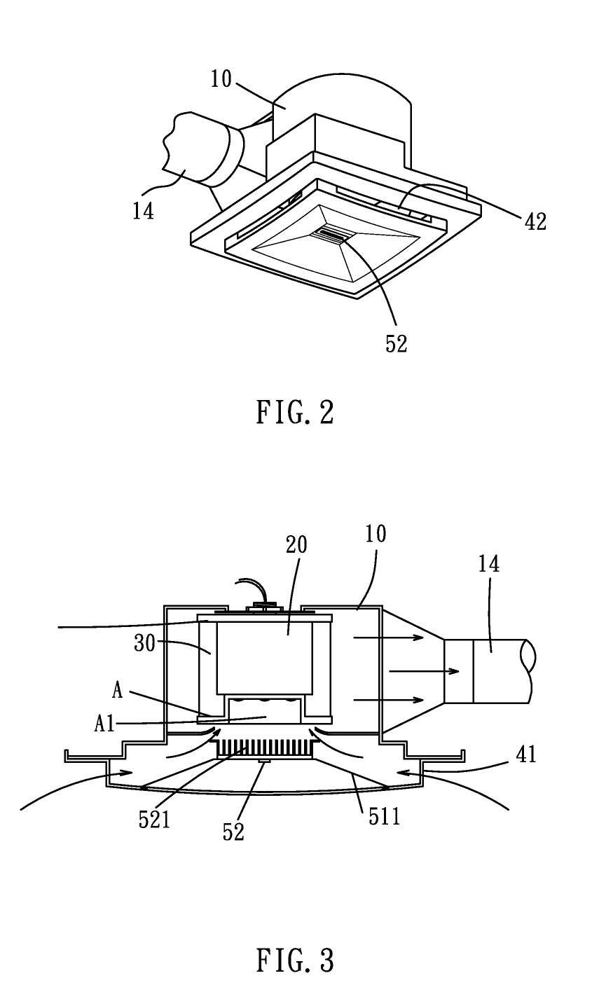

The housing 10 is defined with an axial inner space 11 with its open side facing downward, and the housing 10 is further defined with a vent 12 located above the inner space 11. In a lateral side of the housing 10 is formed a circular-shaped exhaust hole 13 in communication with the vent 12 so that the inner space 11, the vent 12 and the exhaust hole 13 are in communication with one another. The exhaust hole 13 is connected with an exhaust pipe 14 (as shown in FIG. 2) for discharging the air out of the room in which the exhaust fan is installed. The inner space 11 is formed in a rectangular shape and the vent 12 is formed in a circular shape.

The external rotor brushless DC motor 20 includes a stator, a rotor and a controller (not shown) and is formed with an annular flange at one end thereof. On the flange is disposed a fixing member (not shown) for jointing the external rotor brushless DC motor 20 to the inner space 11 of the housing 10. A shaft-connection portion 21 (for connecting the shaft of the external rotor brushless DC motor) extends out of the end of the external rotor brushless DC motor 20 where the flange is located. At the shaft-connection portion 21 are connected power cables 22 for connecting with the controller.

The turbo fan 30 is mounted outside the external rotor brushless DC motor 20 and is rotated by it. An air deflector A formed in the shape of the vent 12 is fixed to the lower periphery of the vent 12 and is defined with an air flow guiding hole A1 which opens toward the turbo fan 30 above the air deflector A, so that when the turbo fan 30 rotates, the air deflector A can increase the air pressure inside the housing, thus enhancing the exhaust effect of the exhaust fan.

The cover 40 is a rectangular structure positioned at the open side of the housing 10 and is centrally defined with a hole 43 for connecting the inner space 11. A rectangular guiding frame 41 with a predetermined thickness vertically extends downward from the lower periphery of the hole 43. In each of the four sides of the rectangular guiding frame 41 is defined an air guiding hole 42 which is in communication with the hole 43 and the inner space 11 so as to connect the inner space 11 to the room where the air exhaust fan is installed. When the external rotor brushless DC motor 20 rotates the turbo fan 30, the turbo fan 30 can suck air into the inner space 11 of the housing 10 through the air guiding hole 42 and discharge it through the exhaust pipe 14.

The cover 40 is disposed at the inner space 11 of the housing 10 and is additionally provided with the LED illumination device 50 which is electrically connected to the external rotor brushless DC motor 20. The LED illumination device 50 includes a light reflecting board 51, a LED illumination member 52 and a transparent board 53. The light reflecting board 51 is disposed between the housing 10 and the cover 40 can be in an arbitrary shape, and it is formed in a rectangular shape in this embodiment. The light reflecting board 51 consists of four slanted pieces tapered toward the center of the rectangular shape of the light reflecting board 51 so as to form a trumpet space 512 toward the cover 40 and a through hole 511 in the center of the trumpet space 512. The LED illumination member 52 is disposed outside the through hole 511 at the top of the light reflecting board 51. The LED illumination member 52 is such a single packaged (in circular or rectangular package) LED which has been integrally formed with a heat sink 521 before being delivered from the factory. In order to be bright enough, the LED illumination member 52 must has a power rating of 5 watt or above. The exhaust fan can also be provided with a luminance control device (not shown) capable of adjusting the light of the LED from while into yellow (or from yellow gradually into white) to create a different atmosphere. The illumination device is miniaturized, power saving and has a long service life due to the use of high power and luminance LED illumination member 52.

The transparent board 53 is formed in a rectangular shape for sealing the hole 43 of the cover 40 and is made of glass or acrylic materials with high optical transparence or can be made of light diffusion plate. The transparent board 53 is engaged in the hole 43 for improving the illumination effect of the LED illumination member 52 while protecting the LED illumination member 52 from being damaged, such as by moisture or external factors.

Referring to FIG. 2 again, in assembly, the cover 40 is used to assemble the LED illumination device 50, the turbo fan 30 and the external rotor brushless DC motor 20 together to the open side of the housing 10 in a detachable manner, and the external rotor brushless DC motor 20 and the turbo 30 are sealed in the inner space 11 of the housing 10 by the cover 40.

When a user enters the room and turns on the switch, the external rotor brushless DC motor 20 will rotate the turbo fan 30 to suck the air (hot air or stink air) out of the room via the air guiding holes 42 into the inner space 11 and then discharge it from the exhaust pipe 14. Meanwhile, the LED illumination member 52 is also switched on to illuminate the room (as shown in FIG. 3).

With the above arrangements, the exhaust fan with the external rotor brushless DC motor and the LED illumination device has the following advantages:

First, with the use of the external rotor brushless DC motor, the exhaust fan of the present invention can increase its rotation speed with a relatively small power, considerably reducing the power consumption and noise. On top of that, the reduction in power consumption of the external rotor brushless DC motor can lower the carbon emission of the exhaust fan, so the exhaust fan is not only environmentally friendly but also energy saving.

Second, the uses of the external rotor brushless DC motor and the low voltage driven LED illumination device make the exhaust fan of the present invention safer than the conventional AC motor driven exhaust fan.

Third, with the use of the single packaged LED illumination member cooperating with the external rotor brushless DC motor, not only the single packaged heat sink can dissipate the heat, but also the turbo fan can discharge the heat generated from the high power LED illumination member sealed in the inner space, so that the heat dissipation problem is solved.

Fourth, the air deflector A disposed below the turbo fan 30 improves the air sucking effect of the air guiding holes 42 in such a manner that the air is collectively sucked in the air flow guiding hole A1 and discharged out of the room, considerably improving the exhaust effect of the exhaust fan.

Fifth, the method of arranging the LED illumination member 52 inside the external rotor brushless DC motor 20 effectively and organically integrates the exhaust fan with the illumination device, thus beautifying the ceiling of the room.

While we have shown and described various embodiments in accordance with the present invention, it is clear to those skilled in the art that further embodiments may be made without departing from the scope of the present invention.

What is claimed is:

1. An external rotor brushless DC motor driven exhaust fan, comprising:
a housing defined with an axial inner space with its open side facing downward and a vent located above the inner space, in a predetermined portion of the housing being formed an exhaust hole in communication with the vent;
a cover detachably assembled to the open side of the housing for sealing the open side of the housing, in each side of a rectangular guiding frame of the cover being defined an air guiding hole;
an external rotor brushless DC motor disposed at the vent and provided with a turbo fan;
a LED illumination device disposed in a space defined between the housing and the cover and electrically connected to the external rotor brushless DC motor;
when the external rotor brushless DC motor is turned on, it will rotate the turbo fan so as to suck air of room via the air guiding hole and then discharge it out of the room, meanwhile, the LED illumination device is turned on to illuminate the room.

2. The external rotor brushless DC motor driven exhaust fan as claimed in claim 1, wherein an air deflector formed in the shape of the vent is fixed to a lower periphery of the vent and is defined with an air flow guiding hole which opens toward the turbo fan above the air deflector, the exhaust hole is connected with an exhaust pipe for discharging air out of the room.

3. The external rotor brushless DC motor driven exhaust fan as claimed in claim 1, wherein the turbo fan is directly rotated by the external rotor brushless DC motor.

4. The external rotor brushless DC motor driven exhaust fan as claimed in claim 2, wherein the LED illumination device is disposed between the housing and the cover, the cover is a rectangular structure positioned at the open side of the housing and is centrally defined with a hole for connecting the inner space, a rectangular guiding frame with a predetermined thickness vertically extends downward from a lower periphery of the hole, in at least one side of the rectangular guiding frame is defined an air guiding hole in communication with the inner space.

5. The external rotor brushless DC motor driven exhaust fan as claimed in claim 4, wherein the LED illumination device includes a light reflecting board, a LED illumination member and a transparent board, the LED illumination member is disposed at a top of the light reflecting board, and the transparent board is used to seal the hole of the cover.

6. The external rotor brushless DC motor driven exhaust fan as claimed in claim 5, wherein the light reflecting board consists of four slanted pieces tapered toward a center of the light reflecting board so as to form a trumpet space toward the cover and a through hole in a center of the trumpet space, the LED illumination member is disposed outside the through hole.

7. The external rotor brushless DC motor driven exhaust fan as claimed in claim 5, wherein the transparent board is made of glass or acrylic.

8. The external rotor brushless DC motor driven exhaust fan as claimed in claim 5, wherein the LED illumination member is a single circular packaged LED with a power rating of above 5 watt.

9. The external rotor brushless DC motor driven exhaust fan as claimed in claim 5, wherein the LED illumination member is a rectangular single packaged LED with a power rating of above 5 watt.

10. The external rotor brushless DC motor driven exhaust fan as claimed in claim 5, wherein the LED illumination device is provided with an luminance control device capable of adjusting color of the light emitted from the LED illumination member.
